(19) United States
(12) Patent Application Publication
(10) Pub. No.: US 2013/0193350 A1
(43) Pub. Date: Aug. 1, 2013

(54) WAFER CURING APPARATUS HAVING IMPROVED SHRINKAGE

(71) Applicants: Yu-Ying Lu, Zhubei City (TW); Ding-I Liu, Hsinchu City (TW); Kuo-Shu Tseng, Taichung City (TW); Yin-Bin Tseng, Hsinchu City (TW); Tsung-Dar Lee, Hualien City (TW); Wen-Hsiang Cheng, Taichung City (TW)

(72) Inventors: Yu-Ying Lu, Zhubei City (TW); Ding-I Liu, Hsinchu City (TW); Kuo-Shu Tseng, Taichung City (TW); Yin-Bin Tseng, Hsinchu City (TW); Tsung-Dar Lee, Hualien City (TW); Wen-Hsiang Cheng, Taichung City (TW)

(73) Assignee: TAIWAN SEMICONDUCTOR MANUFACTURING COMPANY, LTD., Hsinchu (TW)

(21) Appl. No.: 13/363,964

(22) Filed: Feb. 1, 2012

(51) Int. Cl. B01J 19/12

(52) U.S. Cl. 250/492.1

(57) ABSTRACT

A wafer curing apparatus including a plate configured to pass ultraviolet light. The wafer curing apparatus further includes an antireflective coating on a light incident surface of the plate. The antireflective coating has an opening in a central portion thereof. A method of curing a wafer including emitting ultraviolet light from an ultraviolet light source. The method further includes transmitting the ultraviolet light through an ultraviolet transmissive plate having an antireflective coating thereon. The antireflective coating including an opening in a central portion thereof. The method further includes irradiating a wafer with the ultraviolet light transmitted through the ultraviolet transmissive plate.

### BACKGROUND

As technology nodes shrink, in some integrated circuit designs spacing between features in a semiconductor device decreases and issues such as parasitic capacitance become more prevalent. Low k dielectric materials are used as interlayer material to reduce parasitic capacitance and increase speed in circuit components. A conventional method of creating a low k dielectric material is to cure a wafer using ultraviolet radiation to increase the porosity of the wafer. The amount of light incident on the wafer determines the increase in porosity.

Uneven curing produces electrical property variations across the wafer surface. These variations cause large deviations between subsequently cured wafers.

Curing is measured using percent shrinkage with respect to the original wafer thickness. As the degree of curing increases, the percent shrinkage increases because more material is removed from the wafer to increase porosity. Some techniques form wafers with high percent shrinkage in the central region and lower percent shrinkage on the outer portion because the amount of light passing through the quartz plate decreases toward the outer portion of the quartz plate.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. It is emphasized that, in accordance with standard practice in the industry various features may not be drawn to scale and are used for illustration purposes only. In fact, the dimensions of the various features in the drawings may be arbitrarily increased or reduced for clarity of discussion.

FIG. 1 is a side view diagram of a wafer curing apparatus according to one or more embodiments.

FIG. 2 is a top view diagram of an antireflective coating on a plate according to one or more embodiments.

FIG. 3 is a diagram of a side view of an antireflective coating according to one or more embodiments.

FIG. 4 is a side view diagram of a wafer curing apparatus according to one or more embodiments.

### DESCRIPTION

The following disclosure provides many different embodiments, or examples, for implementing different features of the invention. Specific examples of components and arrangements are described below to simplify the present disclosure. These are of course, merely examples and are not intended to be limiting.

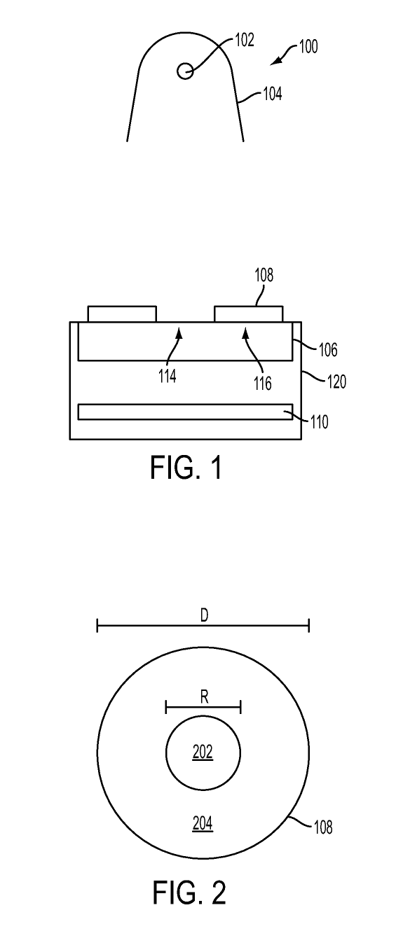

FIG. 1 is a side view diagram of a wafer curing apparatus 100 which includes a reflector 104 configured to collect light emitted by ultraviolet light source 102 and redirects the light toward a plate 106. Plate 106 includes an antireflective coating 108 around an outer portion of the plate. Light passing through plate 106 is incident upon a wafer 110.

In some embodiments, wafer curing apparatus 100 further includes an ultraviolet light source 102. Ultraviolet light source 102 emits light in the ultraviolet spectrum to cure wafer 110. Ultraviolet light source 102 is a metal halide lamp having a wavelength range ranging from about 200 nm to about 450 nm. This range, in some embodiments, is narrower, e.g., from 200 nm to 450 nm. In some embodiments, ultraviolet light source 102 includes a xenon lamp, one or more ultraviolet light emitting diodes, or another suitable ultraviolet light source. Higher intensity ultraviolet light sources cure wafers more rapidly, but can exacerbate non-uniformity problems such as variations in percent shrinkage across a wafer surface.

Ultraviolet light source 102 is positioned at least partially within reflector 104. Reflector 104 has a reflective inner surface in order to collect the light emitted by ultraviolet light source 102 and direct the light to plate 106. Reflector 104 is a concave parabolic reflector. Light reflected off the inner surface of reflector 104 is directed parallel to an axis of reflector 104. In at least some embodiments, all light reflected off the inner surface of reflector 104 is directed parallel to an axis of reflector 104. In some embodiments, reflector 104 has an elliptical shape or other suitable shape.

In some embodiments, a secondary reflector 112 is positioned between reflector 104 and plate 106, as shown in FIG. 4. The secondary reflector is configured to expand the cross section of ultraviolet light received from reflector 104. In some embodiments, the secondary reflector includes multiple reflective surfaces.

Plate 106 is a window of a chamber housing wafer 110 during the curing process. Plate 106 is arranged as a light incident surface of the chamber and transmits ultraviolet light from ultraviolet light source 102 incident on plate 106 into an interior of the chamber. In the embodiment of FIG. 1, plate 106 is quartz. In other embodiments, plate 106 is calcium fluoride, sapphire or other suitable ultraviolet transmissive material. Plate 106 has a thickness ranging from about 24 mm to about 30 mm. In some embodiments, the thickness range is narrower, e.g., from 24 mm to 30 mm. In some embodiments, plate 106 is circular and has a diameter ranging from about 370 mm to about 380 mm. In some embodiments, the diameter range is narrower, e.g., from 370 mm to 380 mm. In other embodiments, plate 106 is rectangular, oval or other suitable shapes.

Antireflective coating 108 is over an incident surface of plate 106. Antireflective coating 108 acts to reduce reflection and redirection of ultraviolet light on the incident surface of plate 106. An incident angle of ultraviolet light at the outer portion 116 of plate 106 is significantly larger than the incident angle in a central portion 114 of plate 106. Antireflective coating 108 modifies the refractive index difference of the light incident surface, to prevent ultraviolet light from being reflected or refracted away from wafer 110. Based on a reduced amount of reflect or refracted light, antireflective film 108 increases the amount of light transmission through plate 106 and onto wafer 110 at the outer portion 116 of plate 106 resulting in more uniform curing of wafer 110.

Wafer 110 is a dielectric wafer. Wafer 110 is silicon dioxide. In other embodiments, wafer 110 is fluorine-doped silicon dioxide, or other suitable dielectric materials. The curing process reduces the dielectric constant, k, of wafer 110. A lower dielectric constant helps reduce parasitic capacitance between features formed in wafer 110.

FIG. 2 depicts a top view of plate 106 and antireflective coating 108. Antireflective coating 108 has a circular shape with a central opening 202. In some embodiments, central opening 202 is less than half of the diameter of plate 106. In other embodiments, central opening 202 is less than one-quarter of the diameter of plate 106. In still other embodiments, central opening 202 is less than 10% of the diameter of plate 106. In some embodiments, antireflective coating 108 extends across the entire light incident surface of plate 106. The central opening 202 is positioned above the central portion 114 of plate 106, where antireflective properties are less necessary, due to an incident angle close to normal. A coated portion 204 extends around the outer portion 116 of plate 106 to decrease reflection of incident light and thereby increase transmission of incident light. In some embodiments, antireflective coating 108 has a uniform thickness. In other embodiments, a thickness of antireflective coating 108 increases from a center of plate 106 to an edge of plate 106. In the embodiment of FIG. 2, central opening 202 has a diameter ranging from about 100 mm to about 105mm. In some embodiments, the diameter range is narrower, e.g., from 100 mm to 105 mm. The area of plate 106 covered by the coating portion 204 is given by the equation:

(D²−R²) (π/4) (2)

where D is the diameter of plate 106 and R is the diameter of central opening 202.

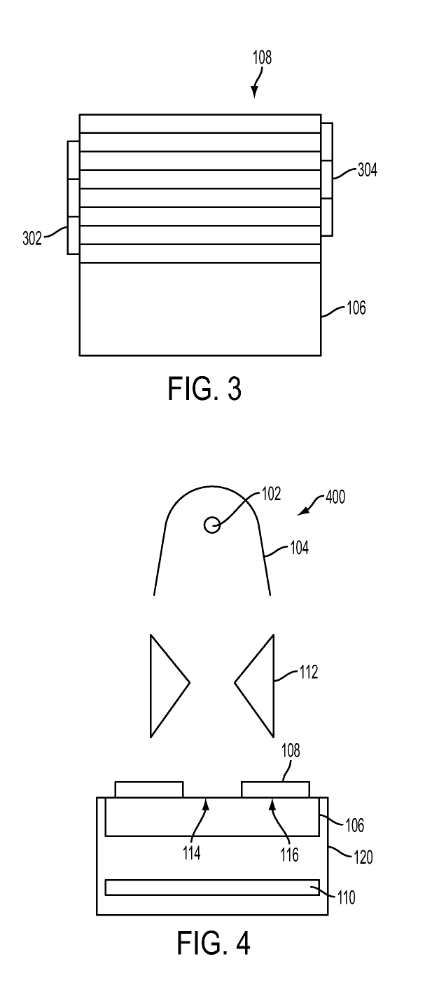

FIG. 3 depicts a side view of antireflective coating 108. The materials used for antireflective coating 108 are hafnium oxide and silicon dioxide. In other embodiments, the materials used for antireflective coating 108 are magnesium fluoride, titanium dioxide, aluminum oxide, zinc oxide or other suitable materials. Antireflective coating 108 is formed by hafnium oxide and silicon dioxide arranged in an alternating structure. Each layer of hafnium oxide 304 is situated between two layers of silicon dioxide 302. The thickness of each individual layer 302 and 304 is about λ/4, where λ is the wavelength of the ultraviolet light source 102. In the embodiment of FIG. 3, the total thickness of antireflective coating 108 ranges from about 0.03 mm to about 0.06 mm. In some embodiments, the total thickness is narrower, e.g., from 0.03 mm to 0.06 mm.

The inclusion of antireflective coating 108 results in more uniform curing of wafer 110. It was found that percent shrinkage uniformity increased by about 18% across a single wafer using antireflective coating 108 versus uncoated plate arrangements. The more uniform curing results in more uniform electrical properties of wafer 110. The higher rate of transmission in an arrangement including antireflective coating 108 also increases curing efficiency because the intensity of light incident on the wafer outer portion 116 is higher than in uncoated plate arrangements. It was found curing efficiency increases by about 10% over uncoated plate arrangements. In at least some embodiments, higher efficiency increases production speed and reduces costs.

Using antireflective coating 108 provides better results in wafer to wafer analysis as well. It was found the standard deviation of percent shrinkage on wafer to wafer testing improved by about 50% over uncoated plate arrangements. The reduced standard deviation allows for improved process optimization because the products formed have more uniform characteristics. In at least some embodiments, reduced variation between wafers also increases production efficiency because more wafers are likely to pass quality control tests.

One aspect of the description relates to a wafer curing apparatus having an ultraviolet light source, a plate for transmitting ultraviolet light, an antireflective coating on the plate and a wafer for receiving light transmitted through the plate and the antireflective coating has an opening in a central portion thereof. Another aspect of the description relates to a method of curing a wafer by emitting ultraviolet light from an ultraviolet light source, transmitting the ultraviolet light through a plate having an antireflective coating thereon and irradiating a wafer with the light transmitted through the plate, where the antireflective coating as an opening in a central portion thereof.

The above description discloses exemplary elements, but they are not necessarily required to be arranged in the order described. Embodiments that combine different claims and/or different embodiments are within the scope of the disclosure and will be apparent to those skilled in the art after reviewing this disclosure.

1. A wafer curing apparatus comprising:
a chamber;
an ultraviolet transmissive plate configured to transmit ultraviolet light into an interior of the chamber;
an antireflective coating on a light incident surface of the plate, wherein the antireflective coating has an opening in a central portion thereof, wherein a ratio of a diameter of the opening to a total diameter of the plate is less than 10%.

2. The wafer curing apparatus of claim 1, further comprising an ultraviolet light source, wherein the ultraviolet light has a wavelength between about 200 nm and about 450 nm.

3. The wafer curing apparatus of claim 1, wherein the antireflective coating comprises hafnium oxide and silicon dioxide.

4. The wafer curing apparatus of claim 3, wherein the antireflective coating is about 0.05 mm thick.

5. The wafer curing apparatus of claim 3, wherein the hafnium oxide and the silicon dioxide are arranged in alternating layers on the plate.

6. The wafer curing apparatus of claim 1, wherein the opening in the antireflective coating has a diameter between about 100 mm to about 105 mm.

7. The wafer curing apparatus of claim 1, wherein the plate has a diameter of about 375 mm.

8. The wafer curing apparatus of claim 1, wherein the plate is about 25 mm thick.

9. The wafer curing apparatus of claim 2, further comprising a reflector configured to gather ultraviolet light emitted by an ultraviolet light source and direct the ultraviolet light toward the plate.

10. A method of curing a wafer comprising:
emitting ultraviolet light from an ultraviolet light source;
transmitting the ultraviolet light through an ultraviolet transmissive plate having an antireflective coating thereon, wherein the antireflective coating has an opening in a central portion thereof, wherein a ratio of a diameter of the opening to a total diameter of the plate is less than 10%; and
irradiating a wafer with the ultraviolet light transmitted through the plate.

11. The method of claim 10, wherein the emitting ultraviolet light includes emitting light having a wavelength between about 200 nm and about 450 nm.

12. The method of claim 10, wherein the transmitting the ultraviolet light includes transmitting light through layers comprising hafnium oxide and silicon dioxide.

13. The method of claim 12, wherein the transmitting ultraviolet light includes transmitting light through the antireflective coating having a thickness of about 0.05 mm.

14. The method of claim 13, wherein the transmitting ultraviolet light includes transmitting light through alternating layers of hafnium oxide and the silicon dioxide.

15. The method of claim 10, wherein the transmitting ultraviolet light includes transmitting light through a central opening in the antireflective layer having a diameter ranging from about 100 mm to about 105 mm.

16. The method of claim 10, wherein the transmitting ultraviolet light includes transmitting light through the plate having diameter of about 375 mm.

17. The method of claim 10, wherein the transmitting ultraviolet light includes transmitting light through the plate having a thickness of about 25 mm.

18. The method of claim 10, further comprising positioning a reflector to collect ultraviolet light emitted by the ultraviolet light source and direct the ultraviolet light toward the plate.

19. A wafer curing apparatus comprising:
an ultraviolet light source configured to emit ultraviolet light;
an ultraviolet transmissive plate configured to receive ultraviolet light from the ultraviolet light source;
a reflector configured to collect ultraviolet light emitted by the ultraviolet light source and direct the ultraviolet light toward the ultraviolet transmissive plate; and
an antireflective coating on a light incident surface of the plate, wherein the antireflective coating has an opening in a central portion thereof, the opening in the antireflective coating has a diameter between about 100 mm and about 105 mm, and a ratio of a diameter of the opening to a total diameter of the plate is less than 10%.

20. The wafer curing apparatus of claim 19, further comprising a secondary reflector between the ultraviolet light source and the plate configured to expand the cross section of the ultraviolet light.
